(19) United States
(12) Patent Application Publication
(10) Pub. No.: US 2022/0242141 A1
(43) Pub. Date: Aug. 4, 2022

(54) WALL PRINTING APPARATUS AND METHOD

(71) Applicants: Dongdong Pan, Wilmington, NC (US); Paul Baron, Wilmington, NC (US)

(72) Inventors: Dongdong Pan, Wilmington, NC (US); Paul Baron, Wilmington, NC (US)

(21) Appl. No.: 17/167,227

(22) Filed: Feb. 4, 2021

(51) Int. Cl. B41J 11/00; B41J 11/42

(52) U.S. Cl. CPC B41J 11/008; B41J 11/42

(57) ABSTRACT

A system and method of wall painting and printing prints an image within a certain o practically no distance from the wall during the wall painting and printing process. The system my use multiple printing heads. The printing heads may be self-cleaning. Printing may resume automatically after a power interruption. Systems may employ ultraviolet and ultrasonic sensors and other equipment

### BACKGROUND

The present application relates to the field of printing technology, and in particular, to a method and device for wall painting and printing, and a wall painting machine.

With the widespread application of wall painting in real life, a wall painting machine capable of automatic wall painting printing has appeared, improving the efficiency of wall painting, and being able to adapt to application scenarios that are not convenient for artificial painting.

However, in the current wall painting machine, since the body of the wall painting machine has a certain width, during the printing process, the image cannot be printed within a certain distance from the wall edge.

### SUMMARY

A system and method of wall painting and printing prints an image within a certain o practically no distance from the wall during the wall painting and printing process. The system my use multiple printing heads. The printing heads may be self-cleaning. Printing may resume automatically after a power interruption. Systems may employ ultraviolet and ultrasonic sensors and other equipment.

An embodiment of the present application provides a method for printing and painting a wall, which is applied to a control terminal. The control terminal is used to control the printing of a wall painting machine. The wall painting machine includes a print head control board and is located on the wall. The first print head and the second print head on both sides of the color plotter, the method includes acquiring the to-be-printed image data that needs to be printed by the first print head as the first to-be-printed image data; sending a first print instruction to the print head control motherboard of the wall painting machine, the first print instruction carrying the first image data to be printed, so that the print head control motherboard controls the first A print head performs printing according to the first image data to be printed, and a moving direction of the wall painting machine is a direction from the first print head to the second print head; sending a first stop instruction to the print head control main board, so that the print head control main board controls the first print head to stop printing, and the image data that was last printed when the first print head stopped printing is used as the stop printing image data; acquire the to-be-printed image data that needs to be printed by the second print head as the second to-be-printed image data, where the second to-be-printed image data is the position of the entire to-be-printed image data and the stop-print image data Adjacent image data; sending a second print instruction to the printhead control motherboard, where the second print instruction carries the second image data to be printed, so that the printhead control motherboard controls the second printhead from the first the print head stops the printing stop position, and prints according to the second image data to be printed.

Further, before the sending a second printing instruction to the print head control motherboard, the method further includes acquiring stop position information indicating a stop position where the first print head stops printing;

The second print instruction also carries the stop position information, so that the print head control motherboard controls the second print head to start from the stop position based on the stop position information, and to perform the second standby Print the image data for printing.

Further, the stop position information is an amount of data that has been printed out of the entire image data when the first print head stops printing.

Further, the above method further includes acquiring the to-be-printed image data that needs to be printed by the first print head as the third to-be-printed image data and the to-be-printed image data that needs to be printed by the second print head as the fourth to-be-printed image data, The print position corresponding to the third to-be-printed image data is used as the third print position, the print position corresponding to the fourth to-be-printed image data is used as the fourth print position, and the third print position is equal to the fourth print position. The spaced horizontal distance is the horizontal distance between the first print head and the second print head;

Sending a third print instruction and a fourth print instruction to the print head control motherboard, the third print instruction carrying the third image data to be printed, and the fourth print instruction carrying the fourth image to be printed Data, so that the print head control main board controls the first print head and the second print head to print simultaneously according to the third image data to be printed and the fourth image data to be printed, respectively.

An embodiment of the present application further provides a wall color printing and printing device, which is applied to a control terminal. The control terminal is used to control the wall color drawing machine to print. The wall color drawing machine includes a print head control motherboard and is located on the wall respectively. The first print head and the second print head on both sides of the body painting machine, the device includes:

A data acquisition module, configured to acquire image data to be printed that needs to be printed by the first print head, as the first image data to be printed;

An instruction sending module is configured to send a first printing instruction to the print head control main board of the wall painting machine, where the first print instruction carries the first image data to be printed, so that the print head controls The motherboard controls the first print head to print according to the first image data to be printed, and the moving direction of the wall painting machine is a direction from the first print head to the second print head;

The instruction sending module is further configured to send a first stop instruction to the print head control motherboard, so that the print head control motherboard controls the first print head to stop printing. Print image data as stop printing image data;

The data acquisition module is further configured to acquire image data to be printed that needs to be printed by the second print head as the second image data to be printed, and the second image data to be printed is all image data of the image to be printed Image data adjacent to the position where the image data to be stopped is printed;

The instruction sending module is further configured to send a second print instruction to the print head control main board, where the second print instruction carries the second image data to be printed, so that the print head control main board controls the The second print head starts from a stop position where the first print head stops printing, and performs printing according to the second image data to be printed.

An embodiment of the present application further provides a control terminal, including: a processor and a machine-readable storage medium, where the machine-readable storage medium stores machine-executable instructions that can be executed by the processor, and the processor is implemented by all processors. The machine-executable instructions described urge the implementation of any of the steps of the wall color printing and printing method applied to a control terminal.

An embodiment of the present application further provides a computer-readable storage medium, where the computer-readable storage medium stores a computer program, and when the computer program is executed by a processor, implements any of the foregoing wail painting printing methods applied to a control terminal A step of.

An embodiment of the present application further provides a computer program product containing instructions, which when executed on a computer, causes the computer to execute any of the steps of the above-mentioned wall painting and printing method applied to a control terminal.

In the above wall painting printing method applied to a control terminal provided in the embodiment of the present application, the wall painting machine has two print heads, which are located on both sides of the wall painting machine, respectively. During the process of printing in the direction of the head, the control terminal sends a first print instruction to the print head control motherboard of the wall painting machine, and the first print instruction carries the first image data to be printed, so that the print head controls the motherboard to control the first print. The head prints according to the first image data to be printed. When the control terminal needs to pause the first print head to stop printing, the control terminal sends a first stop instruction to the print head control main board, so that the print head control main board controls the first print head to stop printing. When the print head stops printing, the last image data to be printed is used as the stop printing image data. Then, the control terminal sends a second print instruction to the print head control main board. The second print instruction carries the second image data to be printed, and the second image to be printed. The image data is the number of images adjacent to the position where the image data is stopped from printing in the entire image data of the image to be printed, That is the next image data to be printed, the print head control board to control the second print head from the first print head is stopped to stop printing start position, according to the second print image data to be printed. With this solution, since the first print head and the second print head are located on both sides of the wall painter, when printing in the direction from the first print head to the second print head, when the print head is limited to the wall painter The limitation of the width of the fuselage. When the second print head is close to the wall and the wall painter can no longer move in the direction of the second print head, the first print head cannot continue to move in the direction of the second print head for printing. You can stop printing at any time, and control the second print head to continue printing from the stop position, so as to print the image to a range within a certain distance from the wall.

The embodiment of the present application further provides a wall painting printing method, which is applied to a print head control main board of the wall painting machine. The wall painting machine further includes first print heads located on both sides of the wall painting machine and A second print head, the method comprising:

Receiving a first print instruction sent by a control terminal, where the first print instruction carries first image data to be printed, and the first image data to be printed is image data to be printed that needs to be printed by the first print head;

Controlling the first print head to print according to the first image data to be printed, and the moving direction of the wall painting machine is a direction from the first print head to the second print head;

After receiving the first stop instruction sent by the control terminal, controlling the first print head to stop printing, and the image data last printed when the first print head stops printing is used as the stop printing image data;

Receiving a second print instruction sent by the control terminal, where the second print instruction carries second image data to be printed, and the second image data to be printed is an image to be printed that needs to be printed by the second print head Data, and the second image data to be printed is image data adjacent to the position where the image data to be stopped is printed out of all image data of the image to be printed;

And controlling the second print head to start printing at a stop position where the first print head stops printing, and perform printing according to the second image data to be printed.

Further, the second print instruction also carries stop position information indicating a stop position where the first print head stops printing;

The controlling the second print head to start printing from a stop position where the first print head stops printing and printing according to the second image data to be printed includes:

Based on the stop position information, controlling the second print head to start printing from the stop position and print according to the second image data to be printed.

Further, the stop position information is an amount of data that has been printed out of the entire image data when the first print head stops printing.

Further, the above method further includes:

Receiving a third print instruction and a fourth print instruction sent by the control terminal, where the third print instruction carries third image data to be printed, and the third image data to be printed needs to be performed by the first print head Printed image data to be printed, the fourth print instruction carries fourth image data to be printed, the fourth image data to be printed is image data to be printed that needs to be printed by the second print head, and the first The print position corresponding to the three to-be-printed image data is used as the third print position, the print position corresponding to the fourth to-be-printed image data is used as the fourth print position, and the third print position is separated from the fourth print position by A horizontal distance is a horizontal distance between the first print head and the second print head;

And controlling the first print head and the second print head to print simultaneously according to the third image data to be printed and the fourth image data to be printed, respectively.

An embodiment of the present application further provides a wall painting printing device applied to a print head control motherboard of the wall painting machine. The wall painting machine further includes first print heads and A second print head, the device includes:

An instruction receiving module, configured to receive a first print instruction sent by a control terminal, where the first print instruction carries first image data to be printed, and the first image data to be printed needs to be printed by the first print head Image data to be printed;

A print control module, configured to control the first print head to print according to the first image data to be printed, and the moving direction of the wall painting machine is from the first print head to the second print head direction;

The print control module is further configured to control the first print head to stop printing after receiving the first stop instruction sent by the control terminal, and the image data last printed when the first print head stops printing is used as a stop Print image data;

The instruction receiving module is further configured to receive a second print instruction sent by the control terminal, where the second print instruction carries second image data to be printed, and the second image data to be printed is required by the first Image data to be printed by the two print heads, and the second image data to be printed is image data adjacent to the position of the image data to be stopped among all image data of the images to be printed;

The print control module is further configured to control the second print head to print from the stop position where the first print head stops printing and perform printing according to the second image data to be printed.

The embodiment of the present application further provides a wall painting machine, comprising: a print head control main board, a first print head and a second print head respectively located on two sides of the wall paint machine, wherein:

The horizontal distance between the first print head and the second print head is the width of the wall painting machine;

The print head control motherboard is used to control the movement and printing of the first print head and the second print head.

Further, it further comprises: a machine-readable storage medium storing machine-executable instructions that can be executed by the processor, and the processor is urged by the machine-executable instructions to: A step of a wall painting printing method applied to a wall painting machine.

An embodiment of the present application further provides a computer-readable storage medium, where the computer-readable storage medium stores a computer program, and when the computer program is executed by a processor, implements any of the foregoing wall paintings applied to a wall painting machine Steps of the printing method.

An embodiment of the present application further provides a computer program product containing instructions, which when executed on a computer, causes the computer to execute any of the steps of the wall painting printing method applied to a wall painting machine described above.

In the above-mentioned wall painting printing method applied to a wall painting machine provided by the embodiment of the application, the wall painting machine has two print heads, which are respectively located on both sides of the wall painting machine, and are directed from the first print head to the second During the printing process in the direction of the print head, the print head control motherboard of the wall painting machine receives the first print instruction sent by the control terminal, and controls the first print head to carry the first image data to be printed according to the first print instruction. When printing is performed, the print head control motherboard controls the first print head to stop printing after receiving the first stop instruction sent by the control terminal. The image data that was last printed when the first print head stopped printing is used as the stop printing image data. After the second print instruction sent by the terminal, the second print instruction carries the second image data to be printed, and the second image data to be printed is image data adjacent to the position where the image data is to be stopped out of all the image data of the images to be printed, That is, for the image data to be printed next, control the stop position where the second print head stops printing from the first print head Beginning to be printed from the second image data to be printed. With this solution, since the first print head and the second print head are located on both sides of the wall painter, when printing in the direction from the first print head to the second print head, when the print head is limited to the wall painter The limitation of the width of the fuselage. When the second print head is close to the wall and the wall painter can no longer move in the direction of the second print head, the first print head cannot continue to move in the direction of the second print head for printing. You can stop printing at any time, and control the second print head to continue printing from the stop position, so as to print the image to a range within a certain distance from the wall.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a block diagram of a system consistent with an embodiment of the system;

FIG. 2 is a schematic structural diagram of a wall color printing system in an embodiment of the present application;

FIG. 3 is one of the flowcharts of the wall color printing and printing method provided in the embodiment of the present application;

FIG. 4 is a second flowchart of a wall color printing and printing method provided in an embodiment of the present application;

FIG. 5 is the third flowchart of the wall color printing and printing method provided in the embodiment of the present application; FIG.

FIG. 6 is the fourth flowchart of the wall color printing and printing method provided in the embodiment of the present application;

FIG. 7 is one of the structural schematic diagrams of a wall color printing and printing device provided in an embodiment of the present application;

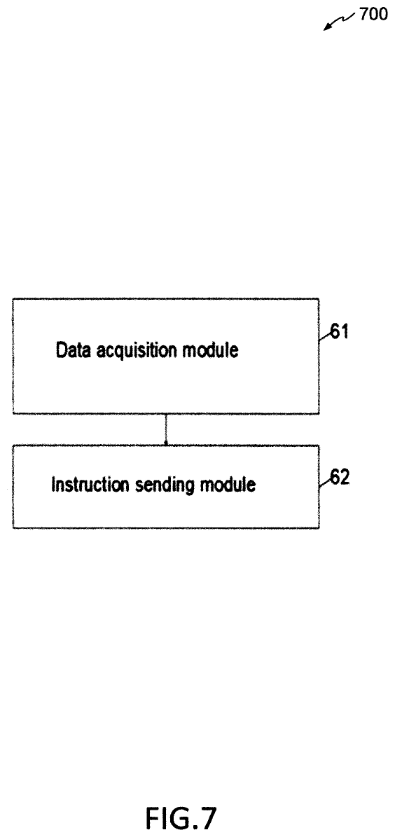

FIG. 8 is a second schematic structural diagram of a wall color printing and printing device provided in an embodiment of the present application;

FIG. 9 is a schematic structural diagram of a control terminal provided in an embodiment of the present application; and

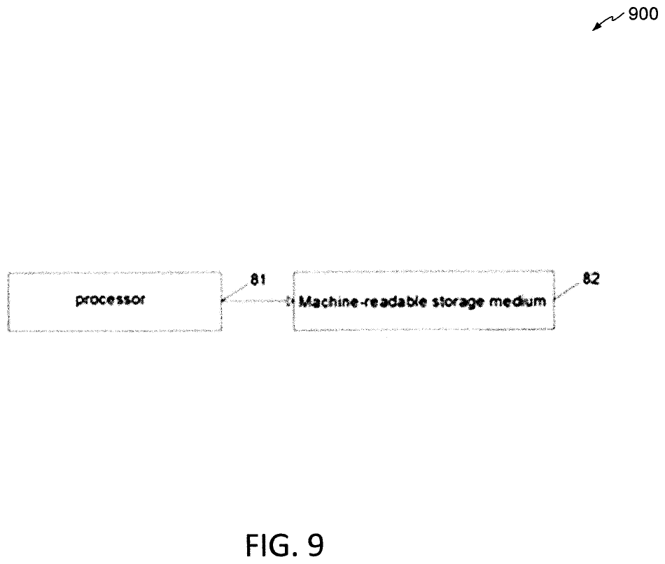

FIG. 10 is a schematic structural diagram of a wall painting machine provided in an embodiment of the present application.

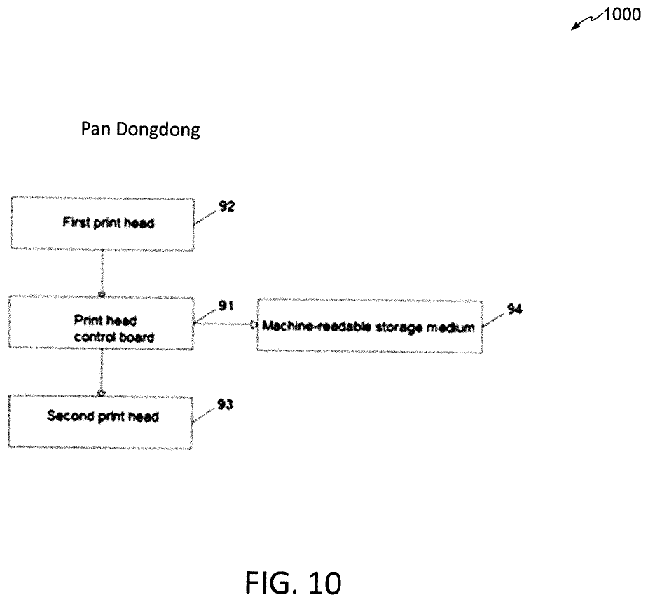

### DETAILED DESCRIPTION

Techniques described herein disclose a wall painting print method. and printing method applied to a control terminal, including: obtaining data from image which to be first print, and sending a printer data instruction to a print head control mainboard of a wall painting print machine to control the first print head to perform print, send a first stop instruction to the print head control motherboard to control the first print head to stop printing, obtain the second image data to be printed, and send a second print instruction to the print head control motherboard to control the second print head to start printing from where the first print head stopped printing, and prints according to the second image data to be printed. With this solution, the image can be printed to a certain distance from the edge of the wall.

In order to give an implementation solution for printing an image to a range within a certain distance from the wall edge during the wall color printing process, the embodiment of the present application provides a wall color printing method and device, and a wall color drawing machine. The accompanying drawings of the specification describe preferred embodiments of the application. It should be understood that the preferred embodiments described herein are only used to illustrate and explain the application, and are not intended to limit the application. And in the case of no conflict, the embodiments in the present application and the features in the embodiments can be combined with each other.

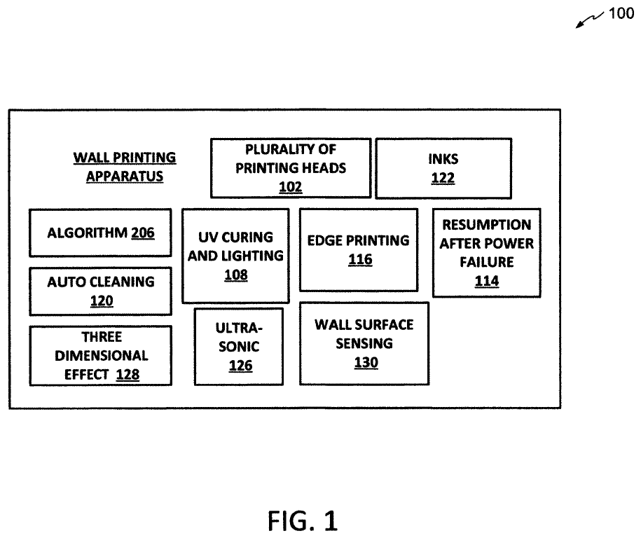

FIG. 1 is a block diagram of an embodiment of the system 100. The embodiment of the system includes an algorithm 106 to coordinate multiple heads 102 concurrently on the same or a different image. For example, an embodiment of the system may include four printer heads. The printer heads 102 may receive instructions to perform different tasks. For instance, one may be halted, while the other two draw separate images.

The multiple head coordination may enable printing in white letters with UV cured ink application process. Inks 122 may include matter to create textured inks produce a 3D effect and can print gold, silver and jade, among others. The multiple heads allow for uneven surfaces since they can come in from different angles. The system includes sensors 130 that automatically sense the flatness of the wall. So the system can print high quality murals on slightly curved walls or over or around imperfections. To expand the size of the printed image, the multiple printing heads stitch left and right, or they can stitch them up and down. The image printed with the feathering effect does not appear to be two parts.

Printing may occur at a wall's edge (e.g., less than 2 cm from a wall's edge). Software 114 allows printing resumes from point of power failure. A program 128 executed by the processor may automatically clean the one more printer head.

The multi-head coordination may achieve speed of printing—up to 850 square ft per hour. Room decoration is recommended to print at the resolution of at least at 720×1440 dpi, which can print at least 140 square feet (e.g. an 8 ft high×18 ft wide or 13 m2) wall image per hour at least at 2880 dpi print resolution. The system may print on any wall surface including glass, metal, with UV cured protection 108. The system may include an ultrasonic sensor 126 for wall preview, up to 4.3 inches (11 cm) print head justification for wall irregularities. The system may print on all absorbent surfaces, e.g., paint, brick, sheet rock, stucco, paper, wood, concrete. The UV-wall printer can also print on non-absorbent surfaces such as glass, tile, and metal.

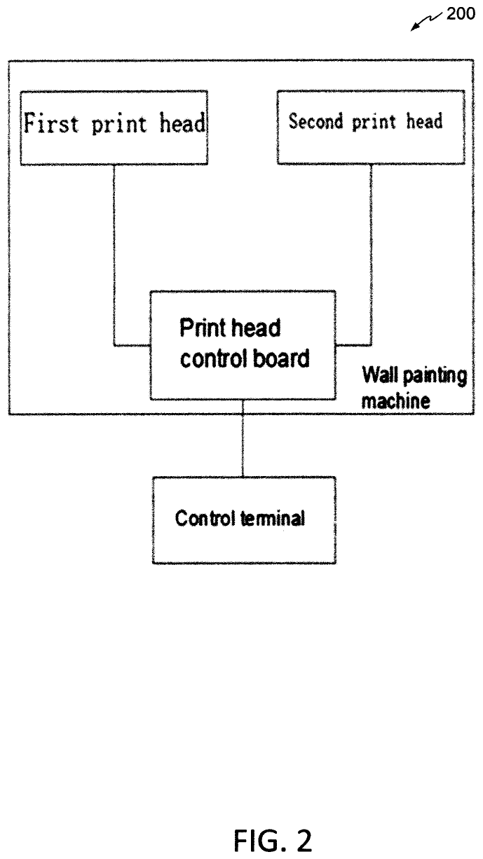

The wall painting scheme provided by the embodiment of the present application can be applied to the wall painting printing system shown in FIG. 2. The wall painting printing system includes a control terminal and a wall painting machine. The wall painting machine includes two the first and second print heads on the side, and the print head control board. The control terminal can also be understood as a print control center, which is used to control the wall painter to print and print on the wall by sending print instructions to the wall painter for the image to be printed, and the wall painter is receiving control After the print instruction sent by the terminal, based on the to-be-printed image data carried in the print instruction, color printing is performed on the wall surface. The first print head and the second print head of the wall painter can be installed on the body of the wall painter, for example, on the movable base of the wall painter, and the first print head and the second print head The horizontal distance between them is the width of the wall painting machine, and it can also be understood that the horizontal distance between the first printing head and the second printing head is not less than the width of the mechanical frame of the wall painting machine.

Since in the embodiment of the present application, the wall painting machine includes two or more print heads, the two or more print heads can be controlled for printing.

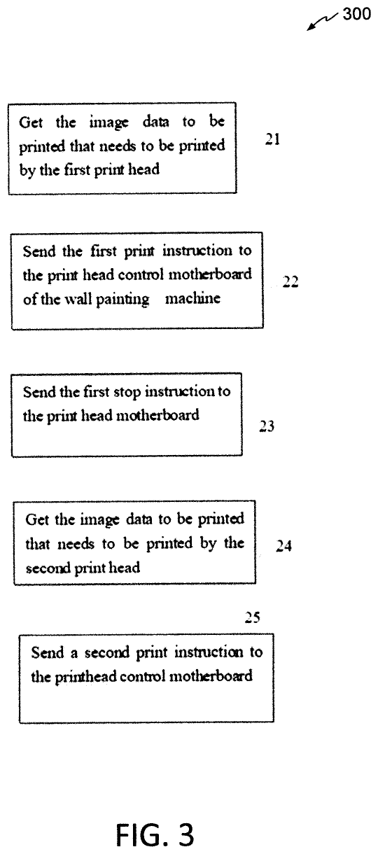

The embodiment of the present application provides a wall painting printing method, which is applied to a control terminal. The control terminal is used to control the printing of the wall painting machine. The wall painting machine includes a print head control motherboard, and the first and second sides of the wall painting machine a print head and a second print head. As shown in FIG. 3, the method includes the following steps:

Step 21: Obtain the image data to be printed that needs to be printed by the first print head as the first image data to be printed.

Step 22: Send a first print instruction to the print head control motherboard of the wall painting machine, where the first print instruction carries the first image data to be printed, so that the print head control motherboard controls the first print head according to the first image data to be printed. When printing is performed, the moving direction of the wall painting machine is a direction from the first print head to the second print head.

Step 23: Send a first stop instruction to the print head control main board, so that the print head control main board controls the first print head to stop printing, and the image data that was last printed when the first print head stopped printing is used as the stop printing image data.

Step 24: Obtain the to-be-printed image data that needs to be printed by the second print head as the second to-be-printed image data. The second to-be-printed image data is the position of the entire to-be-printed image that is adjacent to the position of the image data to be stopped Image data.

Step 25: Send a second print instruction to the print head control motherboard, where the second print instruction carries the second image data to be printed, so that the print head control motherboard controls the second print head to start from the stop position where the first print head stops printing. Printing is performed according to the second image data to be printed.

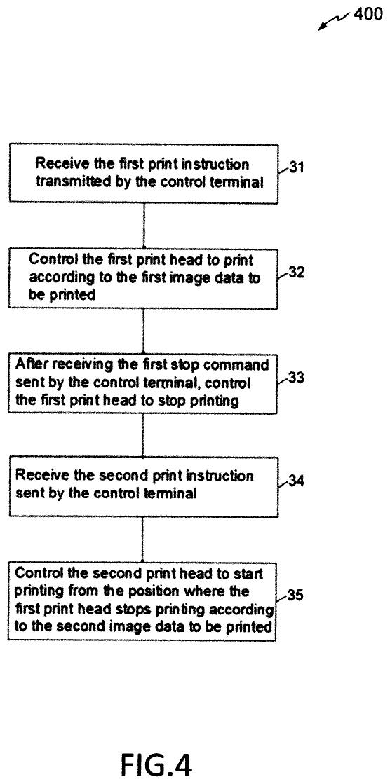

Correspondingly, the embodiment of the present application also provides a wall painting printing method, which is applied to a print head control motherboard of the wall painting machine. The wall painting machine further includes first print heads located on both sides of the wall painting machine and as shown in FIG. 4, the second print head includes the following steps:

Step 31: Receive a first print instruction sent by the control terminal. The first print instruction carries first image data to be printed, and the first image data to be printed is image data to be printed that needs to be printed by the first print head.

Step 32: The first print head is controlled to print according to the first image data to be printed, and the moving direction of the wall painting machine is a direction from the first print head to the second print head.

Step 33: After receiving the first stop instruction sent by the control terminal, control the first print head to stop printing, and the image data that was last printed when the first print head stopped printing is used as the stop printing image data.

Step 34: Receive a second print instruction sent by the control terminal, the second print instruction carries second image data to be printed, the second image data to be printed is image data to be printed that needs to be printed by the second print head, and the second The image data to be printed is image data adjacent to a position where the image data to be stopped is printed among all image data of the images to be printed.

Step 35: Control the second print head to start printing from the stopping position where the first print head stops printing, and print according to the second image data to be printed.

With the above-mentioned wall color printing method provided in the embodiment of the present application, since the first print head and the second print head are located on both sides of the wall color plotter, the printing process is performed in a direction from the first print head to the second print head. When the second print head is close to the wall and the wall painter can no longer move towards the second print head, the first print head cannot continue to move toward the second print head. The second print head moves to print, and at this time, printing can be stopped, and the second print head can be controlled to continue printing from the stopped position, so as to print the image to a certain distance from the wall.

In the above solution provided by the embodiment of the present application, the first print head may be a left print head, the second print head may be a right print head, or the first print head may be a right print head, and the second print head may be The left print head can be used in practical applications.

The solutions provided in the present application will be described in detail below with reference to the drawings and specific embodiments.

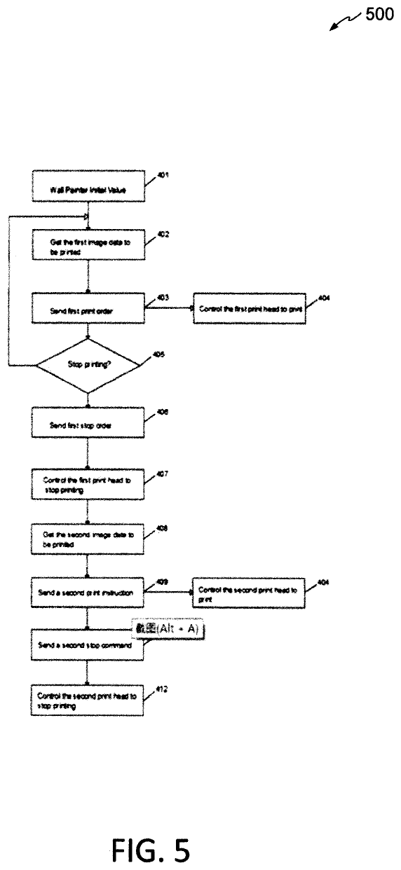

FIG. 5 is a detailed flowchart of an embodiment of a wall color printing and printing method according to an embodiment of the present application, in which a method is described by taking a direction from a first print head to a second print head as a printing direction, It can include the following steps:

Step 401: The information exchange between the control terminal and the wall painter completes the initialization of the wall painter and the positioning of the initial printing position.

When it is determined that the wall painting machine needs to be controlled for wall painting printing, the control terminal sends an initialization instruction to the wall painting machine.

After receiving the initialization instruction, the wall painter performs an initialization operation, and returns an initialization completion response to the control terminal.

Based on the application scenario and actual needs, the initialization operation may include various operations, for example, it may include operations such as mechanical positioning and print head cleaning, which are not limited in the embodiments of the present application.

After receiving the initialization completion response, the control terminal controls the print head of the wall painter to move to the specified position by sending a movement instruction to the wall painter. In the embodiment of the present application, the first print head is controlled to print. Then, the first print head can be controlled to move to a specified position.

For example, the designated position may be an initial printing position for the image to be printed. When the first print head is located on the left side and is printed from left to right, it may specifically be located at the lower left corner of the position of the image to be printed.

Step 402: The control terminal acquires the image data to be printed that needs to be printed by the first print head as the first image data to be printed.

Step 403: The control terminal sends a first print instruction to the print head control motherboard of the wall painting machine, and the first print instruction carries the first image data to be printed.

In one embodiment, the first print instruction may carry identification information indicating that the first print head is used to indicate that the first print instruction is used to instruct the first print head to perform printing.

Step 404: After receiving the first print instruction, the print head control motherboard controls the first print head to print according to the first image data to be printed.

Regarding the above steps 402 to 404, in the embodiment of the present application, the image data to be printed that needs to be continuously printed by the first print head at one time may be carried by a first print instruction and sent to the print head control main board at one time.

It is also possible to divide the image data to be printed which needs to be continuously printed by the first print head at one time into multiple data units, and each data unit is carried by a first print instruction, and sent by a different first print instruction, and sent multiple times Give the printhead control over the motherboard.

For example, the print head can be printed in the vertical order when printing the image. After each horizontal position shift, the print head is printed in the horizontal position in the order from top to bottom or bottom to top. After the printing is completed, And then move horizontally by one step position, and continue to print from top to bottom or bottom to top, and so on. At this time, a data unit can be image data that needs to be printed at a preset number of horizontal positions. For example, a data unit is image data that needs to be printed in a horizontal position. Then, correspondingly, every time a print instruction is received, a vertical print is completed, and then a position of a step is moved, and then a print instruction is received to complete a vertical portrait. Print, and so on.

Step 405: The control terminal determines whether the first print head needs to be stopped for printing. If it is necessary to stop, it proceeds to step 406. If it is not required to stop, it returns to step 402 above to obtain the first image to be printed that needs to be carried in the next first print instruction. data.

In one embodiment, it may be determined based on whether the first image data to be printed carried in the first print instruction sent last time is preset image data, and the preset image data is image data that needs to be printed last when printing is stopped. The preset image data may also be referred to as stopping printing image data. If it is, printing needs to be stopped, and if not, printing does not need to be stopped.

For example, further, when each first print instruction carries image data of one data unit, it can be determined based on whether the number of first print instructions sent is a preset number, where the first preset number The first image data to be printed carried in a print instruction is the above-mentioned image data for stopping printing. If it is, then printing needs to be stopped, and if not, printing does not need to be stopped.

Step 406: The control terminal sends a first stop instruction to the print head control motherboard.

Step 407: After receiving the first stop instruction, the print head control motherboard controls the first print head to stop printing.

Step 408: The control terminal acquires the image data to be printed that needs to be printed by the second print head as the second image data to be printed.

In this step, the stop position information indicating the stop position where the first print head stops printing may also be obtained. The stop position information may specifically be the amount of data that has been printed out of all the image data when the first print head stops printing. The number of data units that have been printed.

Step 409: The control terminal sends a second print instruction to the print head control motherboard, and the second print instruction carries the second image data to be printed.

Further, when the stop position information is also obtained in the above step 408, the second print instruction may also carry the stop position information.

In one embodiment, the second print instruction may carry identification information indicating that the second print head prints, and is used to indicate that the second print instruction is used to instruct the second print head to print.

Step 410: After receiving the second print instruction, the print head control motherboard controls the second print head to start printing from the stop position where the first print head stops printing, and print according to the second image data to be printed.

In this step, when the stop position information is not carried in the second print instruction, the print head control motherboard may record the stop position when stopping the printing of the first print head, and control the second print head to move to the recorded stop position, and then the second print head is controlled to start printing from the stopped position and print according to the second image data to be printed.

When the stop position information is carried in the second print instruction, the print head control motherboard may determine the stop position based on the stop position information, and control the second print head to move to the determined stop position, and then control the second print head from the stop position. The determined stop position starts, and printing is performed according to the second image data to be printed.

In the embodiment of the present application, it is also possible to send a second printing instruction to the print head control main board multiple times, so as to control the second print head to continuously perform position movement and printing.

Step 411: When the second print head needs to be controlled to stop printing, for example, after all the image data of the image to be printed has been sent to the wall painting machine, the control terminal sends a second stop instruction to the print head control motherboard.

Step 412: After receiving the second stop instruction, the print head control motherboard controls the second print head to stop printing.

In the above method flow shown in FIG. 5, after each time the print head control motherboard controls the first print head or the second print head to complete a print, it may also return a print completion response to the control terminal, for example, for the first print head A first print completion response is returned, and a second print completion response is returned for the second print head. After receiving the print completion response, the control terminal sends the next print instruction or sends a stop instruction.

In one embodiment, before starting to print an image to be printed, the control terminal may display a print operation interface, and receive various configuration information input by the user for the image to be printed, such as stop position information, through the print operation interface.

By adopting the wall painting printing method shown in FIG. 5 provided by the embodiment of the present application, since the first print head and the second print head are located on both sides of the wall painting machine, the first print head is directed to the second print head according to In the process of printing in the direction of the first print head, when the second print head is close to the wall and the wall painter cannot move in the direction of the second print head, the first print head is limited. That is, printing cannot be continued in the direction of the second print head. At this time, printing can be stopped and the second print head can be controlled to continue printing from the stopped position, so as to print the image to a certain distance from the wall.

For the wall painting machine with two print heads proposed in the embodiment of the present application, in addition to controlling the first print head and the second print head to print sequentially, it can also control The first print head and the second print head print at the same time. The method flow of controlling the first print head and the second print head at the same time is described in detail below.

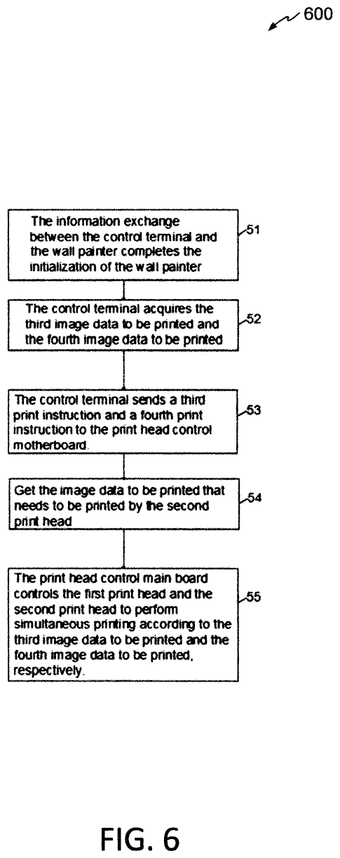

FIG. 6 is a detailed flowchart of an embodiment of a wall color printing and printing method according to an embodiment of the present application, in which a method is described by taking a direction from a first print head to a second print head as a printing direction, It can include the following steps:

Step 51: The information exchange between the control terminal and the wall painter completes the initialization of the wall painter and the positioning of the initial printing position.

When it is determined that the wall painting machine needs to be controlled for wall painting printing, the control terminal sends an initialization instruction to the wall painting machine.

After receiving the initialization instruction, the wall painting machine performs an initialization operation, and returns an initialization completion response to the control terminal.

Based on the application scenario and actual needs, the initialization operation may include various operations, for example, it may include operations such as mechanical positioning and print head cleaning, which are not limited in the embodiments of the present application.

After receiving the initialization completion response, the control terminal controls the print head of the wall painter to move to the specified position by sending a movement instruction to the wall painter. In the embodiment of the present application, the first print head can be controlled to move to the specified position. Because the lateral distance between the first print head and the second print head is fixed, it is also equivalent to controlling the second print head to move to its corresponding designated position at the same time.

For example, the designated position may be an initial printing position for the image to be printed. When the first print head is located on the left side and is printed from left to right, it may specifically be located at the lower left corner of the position of the image to be printed.

In this step, the control terminal controls the movement of the print head of the wall painting machine, which can be controlled by referring to the position of the laser cross mark projected on the wall.

Step 52: The control terminal acquires the image data to be printed that needs to be printed by the first print head as the third image data to be printed, and the image data to be printed that needs to be printed by the second print head as the fourth image data to be printed. Wherein, the print position corresponding to the third image data to be printed is taken as the third print position, the print position corresponding to the fourth image data to be printed is taken as the fourth print position, and the horizontal distance between the third print position and the fourth print position Is the horizontal distance between the first print head and the second print head.

Step 53: The control terminal sends a third print instruction and a fourth print instruction to the print head control motherboard. The third print instruction carries third image data to be printed, and the fourth print instruction carries fourth image data to be printed.

In an embodiment, the third print instruction may carry identification information indicating that the first print head is used to indicate that the third print instruction is used to instruct the first print head to print; the fourth print instruction may carry an indication The identification information printed by the second print head is used to indicate that the fourth print instruction is used to instruct the second print head to print.

Step 54: After receiving the third print instruction and the fourth print instruction, the print head control motherboard controls the first print head and the second print head to perform simultaneous printing according to the third image data to be printed and the fourth image data to be printed, respectively.

That is, the first print head is controlled to print according to the third image data to be printed, and at the same time, the second print head is controlled to print according to the fourth image data to be printed, so that the first print head and the second print head are simultaneously printed.

With regard to the above steps 52 to 54, in the embodiment of the present application, the image data to be printed that needs to be continuously printed by the first print head at one time may be carried by a third print instruction, and sent to the print head control motherboard at one time, The image data to be printed continuously printed by the second print head at one time is carried by a fourth print instruction and sent to the print head control main board at a time.

The image data to be printed which needs to be continuously printed by the first print head at one time can also be split into multiple data units, each data unit being carried by a third print instruction, and sent by a different third print instruction, respectively, and sent multiple times Control the main board for the print head, and split the image data to be printed that needs to be continuously printed by the second print head at one time into multiple data units. Each data unit is carried by a fourth print instruction, and each is printed by a different fourth. Commands are sent to the print head control motherboard multiple times.

For example, the print head can be printed in the vertical order when printing the image. After each horizontal position shift, the print head is printed in the horizontal position in the order from top to bottom or bottom to top. After the printing is completed, And then move horizontally by one step position, and continue to print from top to bottom or bottom to top, and so on. At this time, a data unit can be image data that needs to be printed at a preset number of horizontal positions. For example, a data unit is image data that needs to be printed in a horizontal position. Then, correspondingly, every time a print instruction is received, a vertical print is completed, and then a position of a step is moved, and then a print instruction is received to complete a vertical portrait. Print, and so on.

In one embodiment, before starting to print an image to be printed, the control terminal may display a print operation interface, and receive various configuration information input by the user for the image to be printed through the print operation interface, for example, third image data to be printed The amount of data spaced from the fourth image data to be printed in order to control the terminal to select the third image data to be printed and the fourth image data from all the image data.

By adopting the wall painting printing method shown in FIG. 6 provided in the embodiment of the present application, since the first print head and the second print head can be controlled to print at the same time, the efficiency of wall painting printing is improved, and the same can be achieved. Print the image within a certain distance from the edge of the wall.

In an embodiment of the present invention, the wall color printing and printing methods shown in FIG. 5 and FIG. 6 described above may also be combined. For example, for an image to be printed, during the printing process, the first print head may be controlled first to perform Print, and then control the first print head and the second print head to print at the same time to complete the printing of the image to be printed; you can also control the first print head and the second print head to print at the same time, and then stop the first print head to continue printing The second print head is controlled to print, and the printing of the image to be printed is completed.

In practical applications, for each print head, the instruction mark can be carried in the print instruction to distinguish whether the print head needs to be printed separately or printed with another print head so that the print head of the wall painting machine controls the main board. After receiving the print instruction, the print head can be controlled flexibly and effectively for printing.

Based on the same inventive concept, according to the wall painting and printing method applied to the control terminal provided by the foregoing embodiment of the application, correspondingly, another embodiment of the application also provides a wall painting and printing device, which is located at the control terminal and controls The terminal is used to control the printing of the wall painting machine. The wall painting machine includes a print head control motherboard, and a first print head and a second print head located on both sides of the wall paint machine. This includes:

A data acquisition module 61, configured to acquire image data to be printed that needs to be printed by the first print head, as the first image data to be printed;

An instruction sending module 62 is configured to send a first print instruction to the print head control main board of the wall painting machine, where the first print instruction carries the first image data to be printed, so that the print head The control mainboard controls the first print head to print according to the first image data to be printed, and the moving direction of the wall painting machine is a direction from the first print head to the second print head;

The instruction sending module 62 is further configured to send a first stop instruction to the print head control main board, so that the print head control main board controls the first print head to stop printing, and the first print head stops printing when the first print head stops printing. Image data as stop printing image data;

The data acquisition module 61 is further configured to acquire image data to be printed that needs to be printed by the second print head, as the second image data to be printed, and the second image data to be printed is the entire image data of the image to be printed. Image data adjacent to the position where the image data to be stopped is printed;

The instruction sending module 62 is further configured to send a second printing instruction to the print head control main board, where the second print instruction carries the second image data to be printed, so that the print head control main board controls the first The two print heads start from a stop position where the first print head stops printing, and prints according to the second image data to be printed.

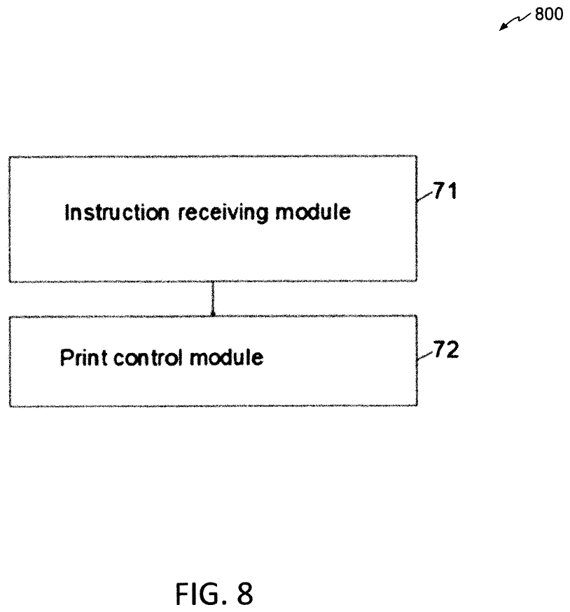

Based on the same inventive concept, according to the wall painting and printing method applied to the wall painting machine provided by the above embodiment of the present application, correspondingly, another embodiment of the present application also provides a wall painting and printing device applied to the wall The print head control board of the color drawing machine. The wall color drawing machine also includes a first printing head and a second printing head respectively located on two sides of the wall drawing machine. The schematic diagram of the structure is shown in FIG. 8 and includes:

The instruction receiving module 71 is configured to receive a first print instruction sent by a control terminal, where the first print instruction carries first image data to be printed, and the first image data to be printed needs to be performed by the first print head. Print image data to be printed;

A print control module 72, configured to control the first print head to print according to the first image data to be printed, and the moving direction of the wall painting machine is from the first print head to the second print head The direction

The print control module 72 is further configured to control the first print head to stop printing after receiving the first stop instruction sent by the control terminal, and the image data last printed when the first print head stops printing is used as the stop printing. Image data

The instruction receiving module 71 is further configured to receive a second print instruction sent by the control terminal, where the second print instruction carries second image data to be printed, and the second image data to be printed is required to be sent by the second Print image data to be printed by the print head, and the second image data to be printed is image data adjacent to the print image stop position among all image data of the images to be printed;

The print control module 72 is further configured to control the second print head to print from the stop position where the first print head stops printing, and perform printing according to the second image data to be printed.

The functions of the above modules may correspond to the corresponding processing steps in the processes shown in FIG. 2 to FIG. 6, which are not repeated here.

Based on the same inventive concept, according to the wall color printing and printing method applied to the control terminal provided by the foregoing embodiment of the present application, correspondingly, another embodiment of the present application also provides a control terminal. Specifically includes: a processor 81 and a machine-readable storage medium 82. The machine-readable storage medium 82 stores machine-executable instructions that can be executed by the processor 81, and the processor 81 is implemented by the machine-executable instructions. Promote: implement the steps of any of the above-mentioned wall color printing and printing methods applied to a control terminal.

An embodiment of the present application further provides a computer-readable storage medium, where the computer-readable storage medium stores a computer program, and when the computer program is executed by a processor, implements any of the foregoing wall painting printing methods applied to a control terminal A step of.

An embodiment of the present application further provides a computer program product containing instructions, which when executed on a computer, causes the computer to execute any of the steps of the above-mentioned wall painting and printing method applied to a control terminal.

Based on the same inventive concept, according to the above-mentioned embodiment of the present application, a wall painting printing method applied to a wall painting machine is provided. Accordingly, another embodiment of the present application also provides a wall painting machine. As shown at 9, it specifically includes: a print head control main board 91, a first print head 92 and a second print head 93 respectively located on both sides of the wall painting machine, wherein:

The horizontal distance between the first print head 92 and the second print head 93 is the width of the wall painting machine;

The print head control main board 91 is used to control the movement and printing of the first print head 92 and the second print head 93.

Further, the wall painting machine further includes: a machine-readable storage medium 94 that stores machine-executable instructions that can be executed by the printhead control motherboard 91, and the printhead control motherboard 91 The machine-executable instructions prompt: to implement the steps of any of the above-mentioned wall painting printing methods applied to a wall painting machine.

An embodiment of the present application further provides a computer-readable storage medium, where the computer-readable storage medium stores a computer program, and when the computer program is executed by a processor, implements any of the foregoing wall paintings applied to a wall painting machine Steps of the printing method.

An embodiment of the present application further provides a computer program product containing instructions, which when executed on a computer, causes the computer to execute any of the steps of the wall painting printing method applied to a wall painting machine described above.

The above-mentioned processor may be a general-purpose processor, including a central processing unit (CPU), a network processor (NP), etc.; it may also be a digital signal processor (DSP), a dedicated integration Circuit (Application Specific Integrated Circuit, ASIC), Field-Programmable Gate Array (FPGA), or other programmable logic devices, discrete gate or transistor logic devices, discrete hardware components.

The wall color printing and printing device provided in the embodiments of the present application can be implemented by a computer program. Those skilled in the art should be able to understand that the above-mentioned module division method is only one of many module division methods. If it is divided into other modules or not divided, as long as the wall painting printing device has the above functions, it should be described in this application. Within the scope of protection.

This application is described with reference to flowcharts and/or block diagrams of methods, devices (systems), and computer program products according to embodiments of the present application. It should be understood that each process and/or block in the flowcharts and/or block diagrams, and combinations of processes and/or blocks in the flowcharts and/or block diagrams can be implemented by computer program instructions. These computer program instructions may be provided to a processor of a general-purpose computer, special-purpose computer, embedded processor, or other programmable data processing device to produce a machine, so that instructions generated by the processor of the computer or other programmable data processing device may be used to Means for implementing the functions specified in one or more flowcharts and/or one or more blocks of the block diagrams.

These computer program instructions may also be stored in a computer-readable memory capable of directing a computer or other programmable data processing device to work in a specific manner such that the instructions stored in the computer-readable memory produce a manufactured article including an instruction device, the instructions The device implements the functions specified in one or more flowcharts and/or one or more blocks of the block diagram.

These computer program instructions can also be loaded onto a computer or other programmable data processing device, so that a series of steps can be performed on the computer or other programmable device to produce a computer-implemented process, which can be executed on the computer or other programmable device. The instructions provide steps for implementing the functions specified in one or more flowcharts and/or one or more blocks of the block diagrams.

Obviously, those skilled in the art can make various modifications and variations to this application without departing from the spirit and scope of this application. In this way, if these modifications and variations of the present application fall within the scope of the claims of the present application and their equivalent technologies, this application also intends to include these modifications and variations.

enable a waste system that includes a processor to perform functions to identify objects, sort materials, sense fullness, compact trash, and connect to a wireless processor and/or user display.

The system may include a steel frame and impact resistance covers, and polypropylene sub containers.

According to another particular implementation, at least one non-transitory computer-readable medium comprising instructions that, in response to execution of the instructions by one or more processors, cause the one or more processors to perform the following operations: receiving, from a user at a user interface of the device, an invocation input and a user query, the invocation input comprising one or more of: a hotword utterance and a gesture, wherein each of a plurality of digital assistants installed on the device are selectively responsive to the invocation input; determining that the user query is related to a previous query that was uttered within a preset period of time and handled by a first assistant of the plurality of digital assistants; and based on the user query being related and uttered within the present period of time, initiating operation of the first digital assistant to respond to the user query. The one or more processors may further be configured to identifying vertical data by classifying a vertical of the user query based on data derived from one or more of heuristics and a neural network.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented by one or more processors of a device, the method comprising:
receiving data of a first image to be printed;
instructing a first print head to perform a first print operation;
halting the first print operation at a first location on a wall surface;
receiving data of a second image to be printed at the first location;
performing a second printing operation; and
halting the second printing operation at a preset distance from an edge of the wall surface.

2. The method of claim 1, before the sending a second print instruction to a processor, further comprising:
acquiring stop position information indicating a stop position where the first print head stops printing;
the second print instruction also carries the stop position information, so that the print head control motherboard controls the second print head to start from the stop position based on the stop position information, and to perform the second standby print the image data for printing.

3. The method of claim 2, wherein the stop position information is an amount of data that has been printed out of all the image data when the first print head stops printing.

4. The method of claim 1, further comprising acquiring the to-be-printed image data that needs to be printed by the first print head as the third to-be-printed image data and the to-be-printed image data that needs to be printed by the second print head as the fourth to-be-printed image data, the print position corresponding to the third to-be-printed image data is used as the third print position, the print position corresponding to the fourth to-be-printed image data is used as the fourth print position, and the third print position is equal to the fourth print position. The spaced horizontal distance is the horizontal distance between the first print head and the second print head.

5. A wall color printing method, characterized in that it is applied to a print head control motherboard of a wall color drawing machine, and the wall color drawing machine further comprises first print heads located on both sides of the wall color drawing machine and a second print head, the method comprising:
receiving a first print instruction sent by a control terminal, where the first print instruction carries first image data to be printed, and the first image data to be printed is image data to be printed that needs to be printed by the first print head;
after receiving the first stop instruction sent by the control terminal, controlling the first print head to stop printing, and the image data last printed when the first print head stops printing is used as the stop printing image data;
receiving a second print instruction sent by the control terminal, where the second print instruction carries second image data to be printed, and the second image data to be printed is an image to be printed that needs to be printed by the second print head data, and the second image data to be printed is image data adjacent to the position where the image data to be stopped is printed out of all image data of the image to be printed; and controlling the second print head to start printing at a stop position where the first print head stops printing, and perform printing according to the second image data to be printed.

6. The method of claim 5, wherein the second print instruction further carries stop position information indicating a stop position where the first print head stops printing, the controlling the second print head to start printing from a stop position where the first print head stops printing and printing according to the second image data to be printed includes based on the stop position information, controlling the second print head to start printing from the stop position and print according to the second image data to be printed.

7. The method of claim 6, wherein the stop position information is an amount of data that has been printed out of all the image data when the first print head stops printing.

8. The method of claim 5, further comprising receiving a third print instruction and a fourth print instruction sent by the control terminal, where the third print instruction carries third image data to be printed, and the third image data to be printed needs to be performed by the first print head printed image data to be printed, the fourth print instruction carries fourth image data to be printed, the fourth image data to be printed is image data to be printed that needs to be printed by the second print head, and the first The print position corresponding to the three to-be-printed image data is used as the third print position, the print position corresponding to the fourth to-be-printed image data is used as the fourth print position, and the third print position is separated from the fourth print position by a horizontal distance is a horizontal distance between the first print head and the second print head.

9. A method printing on a wall, the method comprising:
accessing at a processor a memory storing an image and an algorithm; and
executing the processor to coordinate operation of at least four printer heads, wherein the algorithm enables printing substantially to an edge of a wall.
